(19) United States
(12) Patent Application Publication
(10) Pub. No.: US 2008/0306656 A1
(43) Pub. Date: Dec. 11, 2008

(54) Process for Adjusting an Occupant Protection and/or Comfort Enhancing System, and Occupant Protection and/or Comfort Enhancing System.

(75) Inventors: Karl-Heinz Baumann, Bondorf (DE); Rainer Justen, Altdorf (DE); Martin Lanzerath, Denkendorf (DE); Carsten Lorenz, Grafenau-Doeffingen (DE)

Correspondence Address: CROWELL & MORING LLP;INTELLECTUAL PROPERTY GROUP, P.O. BOX 14300, WASHINGTON, DC, 20044-4300, US

(73) Assignee: Daimler AG, Stuttgart (DE)

(21) Appl. No.: 11/913,608

(22) PCT Filed: Apr. 22, 2006
(86) PCT No.: PCT/EP2006/003725

§ 371 Date: Jun. 11, 2008

(30) Foreign Application Priority Data
May 6, 2005 (DE) 10 2005 021 171.2

(51) Int. Cl. B60R 21/00

(52) U.S. Cl. 701/45

(57) ABSTRACT

The invention relates to a vehicle occupant protection and/or comfort system (1) for a vehicle (10), comprising a plurality of adaptive protection system and comfort components (8.1, 8.2) which are each assigned to a sitting place (SP1 to SPn) and can be adjusted by means of a safety and/or comfort profile (PS, PK) which is related to a vehicle occupant who is occupying the respective sitting place (SP1 to SPn) and can be activated by means of an authentication system (2). The authentication system (2) here comprises a plurality of person identification devices (4.1 to 4.n) which are each assigned to a sitting place (SP1 to SPn) and have the purpose of sensing biometric identification features (IM) of body parts of a vehicle occupant, wherein the vehicle occupant can be identified by means of the sensed biometric identification features (IM) and can be assigned to a sitting place (SP1 to SPn), and wherein a safety and/or comfort profile (PS, PK) which is associated with the vehicle occupant can be activated on a sitting-place-related basis by means of biometric data (BD) which is associated with the identified vehicle occupant.

The invention relates to a method for adjusting a vehicle occupant protection and/or comfort system of a vehicle. Furthermore, the invention relates to a vehicle occupant protection and/or comfort system for carrying out the method, to a person identification device and to a transponder for adjusting a vehicle occupant protection and/or comfort system.

Various methods for adjusting vehicle occupant protection systems such as, for example, seatbelts, airbags, knee upholstery elements and/or displaceable seats, and comfort systems such as, for example, a seat, steering wheel, mirror, air-conditioning system, engine, chassis, are known from the prior art. In this context, specific vehicle occupant data is significant for adjusting the systems in a way which is as precise as possible and is tailored to the vehicle occupant. For this purpose it is known to store such user-specific vehicle occupant data such as age, weight, size, and to call it when required.

It is thus known, for example, from WO 99/01315 for user-specific adjustment of a vehicle with adjustable or settable assemblies such as, for example, an engine, gearbox, chassis, seat, immobilizer or air-conditioning system, firstly to determine the identity of the driver, to call stored user-specific properties and to perform corresponding adjustment of the vehicle systems by means of the identity and the user-specific properties. The user-specific data is stored in a system memory which is fixed to the vehicle and is activated by a suitable identification means, for example voice, chip card, user-related vehicle keys, inputting of a personal identification number, detection of the fingerprint on the gearshift lever or the like. The method presented in this document serves exclusively to adapt the vehicle to the requirements of the driver. There is no provision for the vehicle to be adapted to the vehicle occupants on the other sitting places. An application for carrying out adaptation of vehicle occupant protection systems has not been considered either.

DE 103 06 159 A1 discloses a method for presetting a vehicle occupant protection system which comprises a plurality of adaptive protection system components which are each assigned to a sitting place in the vehicle, and is preset by means of data which is related to the vehicle occupant. Here, the identity of the vehicle occupant occupying the sitting place is determined for at least one sitting place and a stored safety profile which is assigned to the identified person is called, with the protection system components which are assigned to the sitting place being set by means of the safety profile. In this context, in addition to the determination of the identity of the vehicle occupant, it is necessary to input the sitting place of the respective vehicle occupant by means of known person identification devices. For this purpose, the vehicle occupant's name and the sitting place he has occupied is interrogated in a dialogue via a voice communications device.

Furthermore, in order to adapt the individual protection requirement of a vehicle occupant to the case of an impact, vehicle-occupant-specific data such as, for example, the weight of the vehicle occupant, can be sensed by means of a weight sensor which is arranged in the sitting place or can be determined by deriving the possible weight of the vehicle occupant on the basis of the sitting position. However, such methods are subject to a considerable degree of inaccuracy.

The invention is therefore based on the object of specifying a method for adjusting a vehicle occupant protection and/or comfort system which permits simple and reliable adaptation to the vehicle occupants of a vehicle. Furthermore, a particularly suitable vehicle occupant protection and/or comfort system as well as a person identification device and a transponder for adjusting the vehicle occupant protection and/or comfort system are specified.

With respect to the method, the object is achieved by means of the features of claim 1. With respect to the vehicle occupant protection and/or comfort system the object is achieved by means of the features of claim 4. For the person identification device and the transponder, the object is achieved by means of the features of claim 13 and of claim 16, respectively.

An advantage of the invention is that the identification of each vehicle occupant is carried out directly at the sitting place by means of biometric identification features by means of which specific data which is associated with the vehicle occupant, in particular the vehicle occupant's biometric data, for example body weight, body size, sex, pregnancy, body proportions, are automatically called without inputting further data and on a sitting-location-related basis for the person-related adjustment of a vehicle occupant protection and/or comfort system. Additional inputting of the identity of the vehicle occupant and the vehicle occupant's sitting place in the vehicle is reliably avoided in this way. For the person-related adjustment of the vehicle occupant protection and/or comfort system, an associated safety and/or comfort profile for the respective sitting place is thus automatically activated for the identified vehicle occupant by means of his biometric data. In other words: without involving the vehicle occupant the associated biometric data of the vehicle occupant is automatically identified by means of the biometric identification features, and called, and the sitting place is identified and the vehicle-occupant-specific safety and/or comfort profile is activated on a sitting-location-related basis.

Biometric identification features are understood to be, in particular, body-specific features such as, for example, a fingerprint, the facial area, the iris and/or a voice pattern, which uniquely identify the vehicle occupant. The biometric identification data can be used to check the respective vehicle occupant, i.e. his identity, and interrogate individual parameters which are important for vehicle occupant protection and/or individual, vehicle-occupant-specific parameters which are important for comfort. Therefore, on the one hand, biometric data of a vehicle occupant is assigned to the biometric identification data of a vehicle occupant. Biometric data is understood to be, in particular, data which describes the vehicle occupant at a particular time and is thus variable such as, for example, the body size, body weight, proportions of the body. On the other hand, further data such as biographical data of the vehicle occupant, for example name, date of birth, sex, persons to be informed in the event of an emergency and/or medical data, for example state of health, illnesses, medical conditions, blood group, allergies, medicines, can be assigned to the biometric identification data. The biometric data serves above all for performing individual adaptation of the vehicle occupant protection system. The biographical and medical data can be passed on to a recovery center in the event of an accident.

For a direct interrogation of data which is necessary for the safety and comfort adjustment, the biometric identification features which are sensed by means of a person identification device are supplied to a memory system, wherein vehicle-occupant-specific biometric data is called automatically by means of the supplied biometric identification features and transmitted if appropriate. Depending on the type and embodiment of the method it is possible for the safety and/or comfort profile which is associated with the vehicle occupant to be activated automatically on a sitting-location-related basis by means of the sensed biometric identification features and/or by means of the acquired biometric data of the vehicle occupant. For example, safety protection settings, for example stepped activation of an airbag, adjustment of the force level at the seat belt, movement of the seat into a sitting position which is effective in terms of protection, and also comfort settings, for example setting of a radio transmitter, setting of the air-conditioning system, setting of seats, mirrors and the steering system, for the identified vehicle occupant can be performed automatically with reference to the authentication (=checking of the identity of a vehicle occupant) by means of the biometric identification features and with reference to biometric data which is assigned to these features.

For individual and above all preventive protection in the event of an accident by means of presetting of the vehicle occupant protection and/or comfort system adapted to the physiological properties of the vehicle occupant, the latter comprises a plurality of adaptive protection system and comfort components which are each assigned to a sitting place and can be adjusted by means of the personal safety and/or comfort profile of the vehicle occupant. A reversible seatbelt pretensioner, a displaceable seat, an adjustable steering wheel, an adjustable airbag or an adjustable air-conditioning system, for example, are provided as adaptive protection system and comfort components.

The safety and/or comfort profile is related to a vehicle occupant and is activated by means of the authentication system after correct identification of the vehicle occupant. For correct identification of the vehicle occupant and rapid vehicle-occupant-related adjustment of the protection system and/or comfort components, the authentication system expediently comprises a plurality of person identification devices which are each assigned to a sitting place and have the purpose of sensing the biometric identification features of body parts of the vehicle occupant.

In one particularly simple embodiment, the person identification device is embodied as a fingerprint reader. The person identification device is preferably arranged on a sitting-location-related basis in the region of manually operated elements of a vehicle occupant. For this purpose, a depression-shaped recess for receiving at least one fingertip is provided in the region of manually operated elements, for example on the seatbelt lock, on the seatbelt tongue, on the door handle. This makes it possible, in a particularly simple way, for the vehicle occupant to be identified automatically without additional maneuvers when the door handle is activated and/or when the seatbelt tongue is grasped and thus when a vehicle occupant gets into the vehicle and/or puts on his seatbelt, by virtue of the fact that at least one fingerprint reader is arranged in the respective regions of manually operated elements in depression-shaped recesses.

Alternatively or additionally it is possible for the person identification device to be embodied as a face scanner and/or iris scanner. For example, in this context, in the case of a vehicle occupant who has already sat down, the facial area and/or the eye area of the vehicle occupant is recorded by means of a reading device which is located centrally and/or related to the sitting place, and is used as a biometric identification feature for identifying the vehicle occupant. Furthermore, the person identification device can be embodied as a voice communications device. In this context, the vehicle occupant identifies himself with voice control, wherein the vehicle occupant's voice serves as a biometric identification feature. For the purpose of identification, the recorded speech is compared with a stored acoustic speech pattern for the vehicle occupant. A combination of the various identification methods—fingerprint, face, iris and/or voice recognition—is also possible in order, for example, to avoid inaccuracies as a result of plausibility checks.

For rapid identification of a large number of users of the vehicle, the authentication system preferably comprises a memory system. The biometric identification features which are associated with the users of the vehicle are stored for said users in the memory system. The biometric data of the respective vehicle occupant is assigned to the biometric identification features and is used in turn to predefine an associated safety and/or comfort profile so that, by means of the sensed biometric identification features of the vehicle occupant, it is possible to use said vehicle occupant's associated biometric data for vehicle-occupant-specific adjustment of the vehicle occupant protection and/or comfort system by means of the associated safety and/or comfort profile.

In one advantageous development, the memory system is embodied as a transponder. Such a mobile memory system which can be stored in the vehicle permits simple adjustment and storage as well as assignment of the biometric data such as body size and body weight to the biometric identification features of a person such as a fingerprint, image of an iris, image of a face or speech pattern. In this context, the transponder for storing a vehicle-occupant-specific safety and/or comfort profile for the adjustment of the sitting-location-related protection and/or comfort components can be produced by an authorized dealer. The transponder can also be produced for individual adjustment by means of a personal computer. If one of the person identification devices at a sitting place is activated by a vehicle occupant, for example the read-in fingerprint is transmitted automatically to the transponder which is stored, for example, in the glove compartment, and said fingerprint is compared with the data stored on the transponder. If the read-in fingerprint corresponds to the stored data, the associated biometric data and/or the associated safety and/or comfort profile are called and activated so that the protection system and comfort components are adjusted on a sitting-place-related and user-specific basis.

Alternatively or additionally to the mobile memory system which can be stored in the vehicle, the latter can also be embodied as a memory which is fixed to the vehicle. For this purpose, the biometric data which is associated with the identified vehicle occupant and/or the vehicle occupant's associated safety and/or comfort profile can be transmitted via a radio link and/or a databus link.

Exemplary embodiments of the invention are explained in more detail with reference to a drawing, in which:

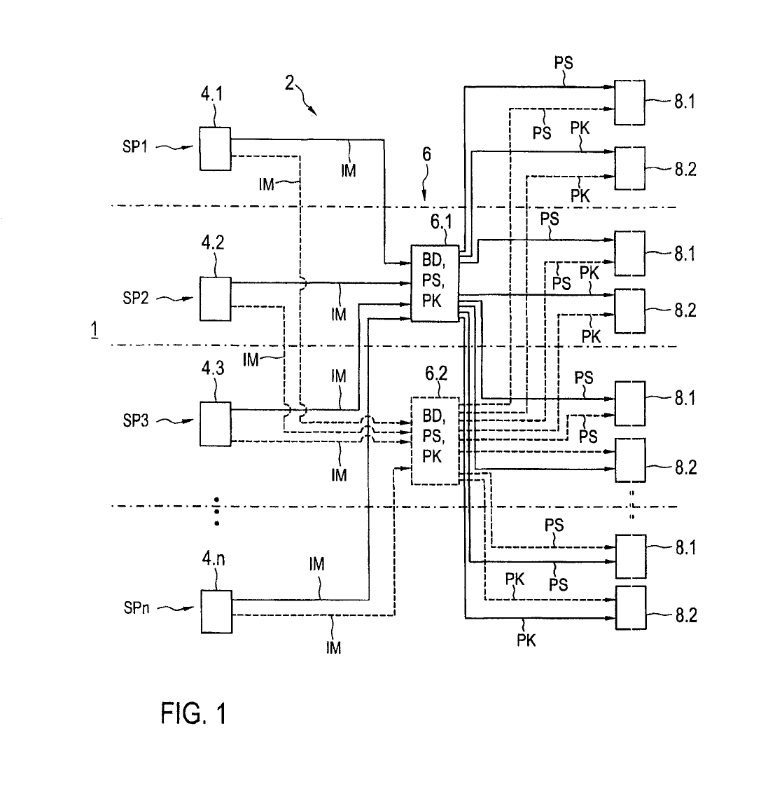

FIG. 1 is a schematic view of a vehicle occupant protection and/or comfort system having an authentication system which comprises a plurality of person identification devices, and a plurality of protection system and comfort components,

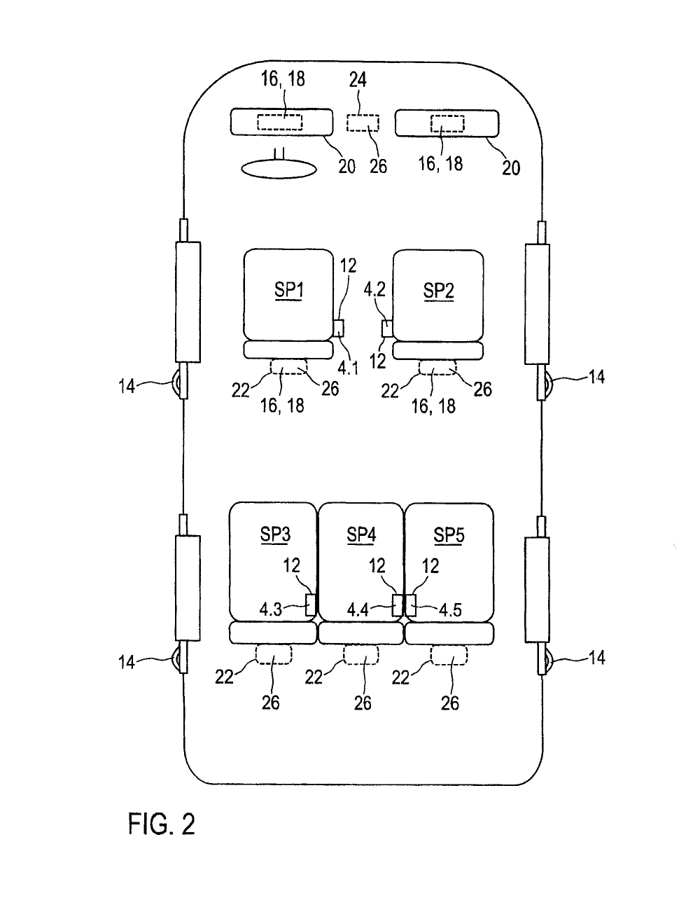

FIG. 2 is a schematic view of a vehicle having a vehicle occupant protection and/or comfort system according to FIG. 1, and

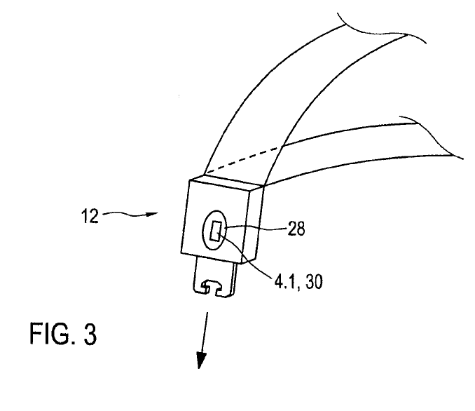

FIG. 3 is a schematic view of a person identification device on a seatbelt lock.

Parts which correspond to one another have been provided with the same reference symbols in all the figures.

FIG. 1 shows a vehicle occupant protection and comfort system 1. The vehicle occupant protection and comfort system 1 comprises two embodiments, which are separate but can also be combined, for a means for individual authentication with automatic user-specific adjustment of the vehicle occupant protection and comfort system 1.

For this purpose, the vehicle occupant protection and comfort system 1 has an authentication system 2 which comprises a plurality of person identification devices 4.1 to 4.n and at least one memory system 6. The respective person identification device 4.1 to 4.n is embodied, for example, as a fingerprint reader, as a face scanner, an iris scanner and/or a voice recognition device. By means of the person identification device 4.1 to 4.n, biometric identification features IM of body parts of a vehicle occupant or user at a sitting place SP1 to SPn are sensed. The biometric identification features IM which are sensed on a sitting-place-related basis are supplied to the memory system 6, for example via a CAN bus, via a radio link or via a Bluetooth link.

Depending on the embodiment of the authentication means, the memory system 6 is embodied in a first mobile variant as a transponder 6.1 (=illustrated using solid lines) and in a second vehicle-supported embodiment as a memory 6.2 (=illustrated using dashed lines) which is fixed to the vehicle. The memory system 6 can thus be stored centrally in a control unit (not illustrated in more detail). Alternatively or additionally, when the device is embodied as a transponder, the memory system 6 can be stored in the form of a mobile safety card, for example can be carried by the vehicle occupant himself, or stored at any desired location in the vehicle, for example in the glove compartment.

Biometric data BD which is stored in the memory system 6 is called by means of the biometric identification features IM, which are supplied to the memory system 6, of the vehicle occupant occupying one of the sitting places SP1 to SPn, and said data BD is used to activate the vehicle-occupant-specific safety profile PS and/or comfort profile PK for adjusting protection system components 8.1 or comfort components 8.2 at the respective sitting place SP1 to SPn.

For example sitting-place-related airbags, the seatbelt or the respective seat are adjusted on a vehicle-occupant-specific basis as protection system components 8.1. In the case of the seat, for example a sitting position which is effective in terms of protection is assumed by moving or adjusting an adjustable headrest position, the inclination of the backrest, the height of the seat and/or inclination of the seat. For example the respective seat, components of an air-conditioning system, audio/video components, are adjusted as comfort components 8.2 to the wishes of the identified vehicle occupant at the respective sitting place SP1 to SPn.

The safety profile PS comprises here the adjustment of protection system components 8.1 which are effective in terms of protection, taking into account the biometric data BD of the vehicle occupant who is occupying the sitting place SP1 to SPn. The comfort profile PK comprises, in contrast, the adjustment of comfort components 8.2 of the respective sitting place SP1 to SPn with reference to wishes of the vehicle occupant. In this context, two profiles, the safety profile PS and the comfort profile PK, can be activated for the same component, for example the seat, in which case the safety profile PS is set with priority if a critical situation is detected.

In the text which follows, the two types of authentication are described in more detail. Depending on the equipment of the vehicle, two types of authentication may be present or only one of them may be present.

In the vehicle-supported variant, one or more biometric identification features IM, for example one or more fingerprints, of the vehicle occupant who is occupying the respective sitting place SP1 to SPn, are read in by means of the sitting-place-related person identification device 4.1 to 4.n. In addition, when the system which is fixed to the vehicle is initialized, the biometric data BD of the vehicle occupant has to be stored once in the memory 6.2. For example the vehicle occupant or person data such as the biometric data BD, for example body weight, body size, sex, the biographical data, for example name, date of birth, address, and/or medical data such as blood group, illnesses, allergies, can be stored in the memory 6.2 by inputting by keyboard. Data has to be input only when the device is first carried in the vehicle. The biographical data is not necessarily a component of the data record. As a result, in the case of the authentication, only a small number of particular biometric data items BD are to be assigned and the vehicle-occupant-specific and sitting-place-related comfort profile PK or safety profile PS is then activated with reference to said data. The vehicle-supported method is suitable in particular for a vehicle with frequently changing persons.

In the mobile variant, the biometric identification features IM, the biometric data BD, the safety and comfort profiles PS, PK and, if appropriate, further data such as biographical data and/or medical data, are stored on the transponder 6.1. This can be done, for example, by means of an authorized dealer. The transponder 6.1 can also be produced individually. When the biometric identification features IM are read in at one of the sitting places SP1 to SPn, said data is transmitted automatically to the transponder 6.1 and compared with data stored on the transponder 6.1. If the data items correspond, the biometric data BD is called and used to activate the safety and/or comfort profile PS and PK by virtue of the fact that said data is transmitted to the respective protection system and/or comfort components 8.1 and 8.2 and used to set the latter there.

The assignment of a sitting place to the vehicle occupant is done automatically by the arrangement of person identification devices 4.1 to 4.n at each sitting place SP1 to SPn.

If the transmitted biometric identification features IM are not identified, i.e. no data on a vehicle occupant is stored on the memory system 6, a request to input person-related vehicle occupant data and the vehicle occupant's wishes for a comfort setting of the seat can be made. If no input occurs, a standard setting of the protection system components 8.1 and/or comfort components 8.2 is made.

FIG. 2 shows a vehicle 10 with a plurality of sitting places SP1 to SP5. The authentication system 4 comprises a plurality of person identification devices 4.1 to 4.5 at each sitting place SP1 to SP5. For example, a fingerprint reader is arranged as a person identification device 4.1 to 4.5 in the region of the respective seatbelt lock 12 and/or the seatbelt tongue at each sitting place SP1 to SP5. In addition or alternatively, a fingerprint reader can be integrated at the respective door handle 14.

Furthermore, one or more facial area scanners 16 or iris scanners 18 can be arranged, for example, in the sun visor 20 and/or in the headrest 22, for sitting-place-related identification of the facial area and/or of the iris.

It is also possible to arrange a voice communications and voice recognition device 26 as a person identification device 4.1 to 4.5 at a central location, for example in the region of the cockpit 24 and/or on a sitting-place-related basis, for example in the region of the headrest 22.

FIG. 3 shows an embodiment of a person identification device 4.1 which is arranged in the region of a seatbelt lock 12. For simple inputting of the biometric identification features IM, the person identification device 4.1 is arranged in the region of manually operated elements of the vehicle occupant. For this purpose, the seatbelt lock 12 has a depression-shaped recess 28 into which a fingerprint reader 30 is integrated as a person identification device 4.1. When the seatbelt lock 12 is activated, the vehicle occupant places his fingertip in the depression-shaped recess 28 so that the fingerprint is read in by means of the fingerprint reader 30, transmitted to the memory system 6 and used to activate the associated safety and comfort profile PS and PK, respectively.

1-16. (canceled)

17. A method for adjusting at least one of a vehicle occupant protection system and a vehicle occupant comfort system of a vehicle having a plurality of adaptive protection system and comfort components that are each assigned to a sitting place, adjusted by way of at least one of a safety profile and a comfort profile related to a vehicle occupant who is occupying the respective sitting place, and activated by way of an authentication system, comprising:
sensing biometric identification features of body parts of a vehicle occupant on a sitting-place-related basis by way of the authentication system,
using the biometric identification features to identify the vehicle occupant and assigning the features to the sitting place,
calling biometric data associated with the vehicle occupant by way of the biometric identification features, and
using the biometric data for activating, on a sitting-place-related basis, at least one of a safety profile and a comfort profile associated with the vehicle occupant.

18. The method as claimed in claim 17, wherein the biometric identification features are sensed by way of a person identification device and supplied to a memory system, and wherein the biometric data are called automatically by way of the biometric identification features and transmitted if appropriate.

19. The method as claimed in claim 17, wherein the at least one of the safety and comfort profiles related to the vehicle occupant is activated automatically on a sitting-place-related basis by way of the biometric data associated with the vehicle occupant acquired.

20. The method as claimed in claim 18, wherein the at least one of the safety and comfort profiles related to the vehicle occupant is activated automatically on a sitting-place-related basis by way of the biometric data associated with the vehicle occupant acquired.

21. A system providing an occupant of a vehicle with at least one of protection and comfort, comprising:
a plurality of adaptive protection system and comfort components,
sitting places, each of said components assigned to one of the sitting places and adjustable by way of a safety profile, a comfort profile, or both a safety profile and a comfort profile related to the vehicle occupant occupying the one of the sitting places, and
an authentication system by which the components are activatable,
wherein the authentication system comprises a plurality of person identification devices, each of which is assigned to one of the sitting places and is adapted to sense biometric identification features of body parts of the vehicle occupant,
wherein the vehicle occupant can be identified by the sensed biometric identification features and assigned to a sitting place, and
wherein at least one of the safety and comfort profiles associated with the vehicle occupant can be activated on a sitting-location-related basis by biometric data associated with the identified vehicle occupant.

22. The system as claimed in claim 21, wherein at least one of the person identification devices is embodied as a fingerprint reader.

23. The system as claimed in claim 21, wherein at least one of the person identification devices is embodied as a face scanner, an iris scanner, or both a face and an iris scanner.

24. The system as claimed in claim 21, wherein at least one of the person identification devices is embodied as a voice communications device.

25. The system as claimed in claim 21, wherein the authentication system comprises a memory system that can be used to call the biometric data associated with the vehicle occupant by way of the sensed biometric identification features of said vehicle occupant.

26. The system as claimed in claim 25, wherein the memory system is embodied as a mobile transponder.

27. The system as claimed in claim 25, wherein the memory system is embodied as a memory that is fixed to the vehicle.

28. The system as claimed in claim 21, wherein the biometric data can be transmitted via at least one of a radio link and a databus link.

29. The system as claimed in claim 21, wherein the biometric data is used for activating a vehicle-occupant-specific safety profile, comfort profile, or safety and comfort profile on a sitting-place-related basis.

30. A person identification device for a system according to claim 21, wherein a sitting-place-related arrangement is disposed in a region of manually operated elements of a vehicle occupant in the vehicle for sensing biometric identification features of body parts of the vehicle occupant.

31. The person identification device as claimed in claim 30, wherein a depression-shaped recess for receiving at least one fingertip is provided in the region of manually operated elements.

32. The person identification device as claimed in claim 30, wherein at least one fingerprint reader is arranged in the depression-shaped recess.

33. The person identification device as claimed in claim 31, wherein the recess is provided in the seatbelt lock.

34. The person identification device as claimed in claim 31, wherein the recess is provided in the seatbelt tongue.

35. The person identification device as claimed in claim 31, wherein the recess is provided in the door handle.

36. A transponder for a system as claimed in claim 21, wherein the biometric data of a vehicle occupant can be called automatically by way of received biometric identification features of the vehicle occupant, can be transmitted, and can be used to activate a vehicle-occupant-specific safety profile, comfort profile, or safety and comfort profile on a sitting-place-related basis.
